(19) United States
(12) Patent Application Publication
(10) Pub. No.: US 2022/0341482 A1
(43) Pub. Date: Oct. 27, 2022

(54) HYDRAULIC DAMPER

(71) Applicant: Hitachi Astemo, Ltd., Hitachinaka-shi (JP)

(72) Inventor: Takashi TSUKAHARA, Hitachinaka-shi (JP)

(73) Assignee: Hitachi Astemo, Ltd., Hitachinaka-shi (JP)

(21) Appl. No.: 17/858,429

(22) Filed: Jul. 6, 2022

Related U.S. Application Data
(63) Continuation of application No. PCT/JP2020/007015, filed on Feb. 21, 2020.

(51) Int. Cl. F16F 9/49; F16F 9/34; F16F 9/32

(52) U.S. Cl. CPC F16F 9/49; F16F 9/34; F16F 9/3221

(57) ABSTRACT

A hydraulic damper includes: a cylinder extending from one side to the other side and containing liquid; a rod configured to move relative to the cylinder; a first piston configured to move relative to the cylinder inside the cylinder along with relative movement of the rod and generate damping force; a first elastic member inside the cylinder and configured to be displaced along with relative movement of the rod; a second elastic member separate from the first elastic member inside the cylinder and configured to be displaced along with relative movement of the rod; and a second piston separate from the first piston and configured to move relative to the cylinder inside the cylinder, to be always supported by the first and second elastic members so as to be movable inside the cylinder, and to generate damping force that varies according to displacement of the first and second elastic members.

### CROSS-REFERENCE TO RELATED APPLICATIONS

This application is a Continuation of International Application No. PCT/JP2020/007015 filed on Feb. 21, 2020, the content of which is incorporated herein by reference in their entireties. The International Application No. PCT/JP2020/007015 was published in Japanese on Aug. 26, 2021 as International Publication No. WO 2021/166214 under PCT Article 21(2).

### FIELD OF THE INVENTION

The present invention relates to a hydraulic damper.

### BACKGROUND OF THE INVENTION

For example, Japanese Patent Application Laid-Open Publication No. 2014-126092 discloses a shock absorber including: a piston rod movably inserted into a cylinder, the piston rod being coupled to a piston; a damping passage disposed at the piston, the damping passage communicating between an tension-side chamber and a compression-side chamber; a bypass path that bypasses the damping passage, the bypass path communicating between the tension-side chamber and the compression-side chamber via an inside of the piston rod; a shutter movably mounted to the piston rod in an axial direction, the shutter opening and closing a bypass path; a biasing member that biases the shutter to a direction of opening the bypass path; a control spring secured to the cylinder by one end, the control spring being a conical coil spring; and a guide ring mounted to a small-diameter side end of the control spring, the guide ring being slidably in contact with an inner periphery of the cylinder.

### CITATION LIST

### Patent Literature

Patent Literature 1: Japanese Patent Application Laid-Open Publication No. 2014-126092

### Technical Problem

Here, adjustment of damping force conforming to, for example, loading, traveling or other conditions of a vehicle can be achieved by varying generated damping force according to relative positions of a cylinder and a rod.

An object of the present invention is to vary generated damping force according to relative positions of the cylinder and the rod.

### SUMMARY OF THE INVENTION

### Solution to Problem

With the above object in view, an aspect of the present invention relates to a hydraulic damper including: a cylinder configured to extend from one side to the other side and contain liquid; a rod configured to move relative to the cylinder; a first piston configured to move relative to the cylinder inside the cylinder along with relative movement of the rod and generate damping force; a first elastic member having elasticity and provided inside the cylinder, the first elastic member being configured to be displaced along with the relative movement of the rod; a second elastic member having elasticity and provided separately from the first elastic member inside the cylinder, the second elastic member being configured to be displaced along with the relative movement of the rod; and a second piston provided separately from the first piston, the second piston being configured to move relative to the cylinder inside the cylinder, the second piston being configured to be always supported by the first elastic member and the second elastic member such that the second piston is movable inside the cylinder, the second piston being configured to generate damping force that varies according to displacement of the first elastic member and the second elastic member.

### ADVANTAGEOUS EFFECTS OF INVENTION

The present invention allows to vary generated damping force according to relative positions of the cylinder and the rod.

### BRIEF DESCRIPTION OF THE DRAWINGS

FIG. 1 is an entire view of a hydraulic damper of the first embodiment.

FIG. 2 is a sectional view of first and second piston units of the first embodiment.

FIGS. 3A and 3B explain how the hydraulic damper 1 operates during a small stroke state in the first embodiment.

FIG. 4 explains how the hydraulic damper 1 operates during a large stroke state in the first embodiment.

FIG. 5 is a sectional view of first and second piston units of the second embodiment.

FIG. 6 explains how the hydraulic damper 1 operates during a large stroke state in the second embodiment.

FIG. 7 is a sectional view of the first and second piston units of the third embodiment.

FIG. 8 is a sectional view of the first and second piston units of the fourth embodiment.

FIG. 9 is an entire view of the hydraulic damper 1 of the fifth embodiment.

### DETAILED DESCRIPTION OF THE INVENTION

Embodiments of the present invention will be described below in detail with reference to the attached drawings.

### First Embodiment

### Hydraulic damper 1

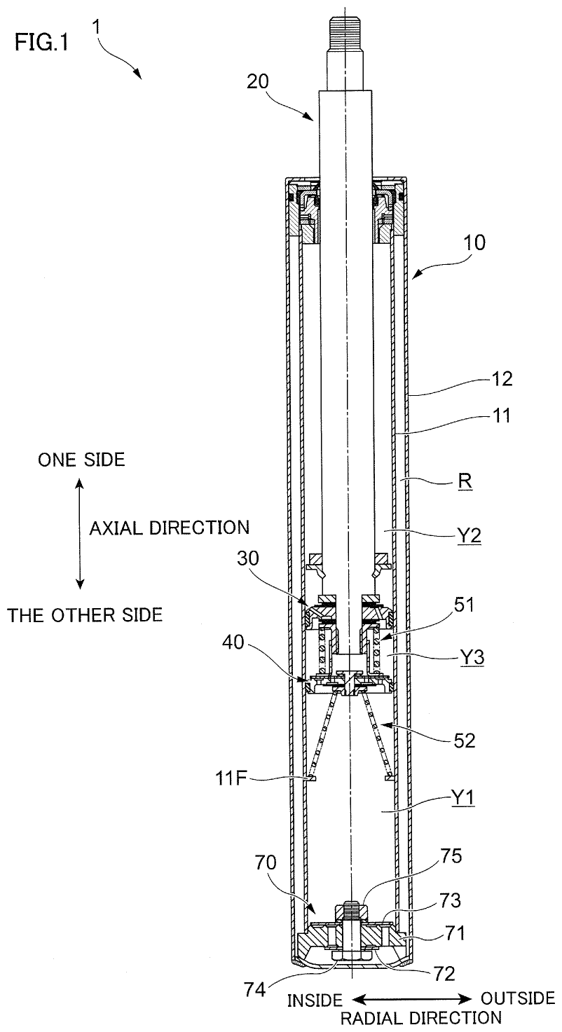

FIG. 1 is an entire view of a hydraulic damper 1 of the first embodiment.

In the description of the present embodiment, a longitudinal direction of the hydraulic damper 1 shown in FIG. 1 may be referred to as an “axial direction”. An upper side of the hydraulic damper 1 in the axial direction may be referred to as “one side”, and a lower side of the hydraulic damper 1 in the axial direction may be referred to as the “other side”. A left-right direction of the hydraulic damper 1 shown in FIG. 1 may be referred to as a “radial direction”. The side closer to the axis in the radial direction may be referred to as an “inside in the radial direction”, and the side away from the axis in the radial direction may be referred to as an “outside in the radial direction”.

As shown in FIG. 1, the hydraulic damper 1 includes a cylinder unit 10 containing oil, and a rod 20. One end of the rod 20 protrudes from the cylinder unit 10 and the other end of the rod 20 is inserted in the cylinder unit 10 such that the rod 20 can slide within the cylinder unit 10. The hydraulic damper 1 further includes a first piston unit 30 (an example of the first piston) provided at the other side end of the rod 20 and generating damping force, and a second piston unit 40 (an example of the second piston) provided on the other side of the first piston unit 30 and generating damping force. The hydraulic damper 1 further includes a first spring 51 (an example of the first elastic member) having elasticity and provided between the first piston unit 30 and the second piston unit 40, and a second spring 52 (an example of the second elastic member) having elasticity and provided on the other side of the second piston unit 40. The hydraulic damper 1 further includes a bottom unit 70 at the other side end of the cylinder unit 10.

In the hydraulic damper 1 of the present embodiment, the second piston unit 40 is always supported by the first spring 51 and the second spring 52 within the cylinder unit 10. The first spring 51 and the second spring 52 are displaced according to the degree to which the rod 20 advances into the cylinder unit 10, whereby the damping force generated from the hydraulic damper 1 is varied.

By way of example, a position of the rod 20 relative to the cylinder unit 10 when a vehicle carrying a few occupants is stopped is defined as a reference position. When, for example, the vehicle carrying a few occupants is traveling straight on a relatively flat road at a constant speed, displacement of the rod 20 from the reference position relative to the cylinder unit 10 is relatively small. In the following description, the state in which such a small displacement of the rod 20 from the reference position relative to the cylinder unit 10 is taking place is referred to as a “small stroke state”. Meanwhile, when, for example, the vehicle squats under acceleration or pitches under hard deceleration or when the vehicle height is lowered due to the vehicle carrying a large number of occupants, displacement of the rod 20 from the reference position relative to the cylinder unit 10 is relatively large. In the following description, the state in which such a large displacement of the rod 20 from the reference position relative to the cylinder unit 10 is taking place is referred to as a “large stroke state”.

The hydraulic damper 1 of the present embodiment is configured to generate a small damping force during the small stroke state. During the large stroke state, on the other hand, the hydraulic damper 1 is configured to generate a large damping force. Below a detailed description will be given of this hydraulic damper 1 capable of varying damping force according to the stroke state.

### Cylinder Unit 10

The cylinder unit 10 includes a first cylinder 11 containing oil and a second cylinder 12 on the outside in the radial direction of the first cylinder 11.

The first cylinder 11 is formed in a cylindrical shape. The first cylinder 11 accommodates, in the inside in the radial direction thereof, the other side of the rod 20, the first piston unit 30, the second piston unit 40, the first spring 51, and the second spring 52 such that they can move in the axial direction.

The first cylinder 11 includes, on an inner surface thereof at the other side in the axial direction, a support 11F to support the second spring 52. The support 11F is secured to the inner surface of the first cylinder 11. The support 11F projects from the inner surface of the first cylinder 11 to the inside in the radial direction.

The mode of supporting the second spring 52 is not limited to usage of the above support 11F. Alternatively, for example, a nut 75 (described later) of the bottom unit 70 may support the second spring 52 as a support therefor. Still alternatively, positions of a bolt 74 (described later) and the nut 75 shown in FIG. 1 may be exchanged such that the bolt 74 serves as a support for the second spring 52.

Still alternatively, the support may be formed by recessing the first cylinder 11 such that at least a portion of the first cylinder 11 projects to the inside in the radial direction.

Still alternatively, the support may be provided between the first cylinder 11 and a valve seat 71. Also, when the hydraulic damper 1 is a so-called mono-tube hydraulic damper only including the first cylinder 11, a free piston that is provided at the other side of the first cylinder 11 and forms a gas chamber for volume compensation for the rod 20 may serve as the support.

The second cylinder 12 is formed in a cylindrical shape. The second cylinder 12 forms a reservoir chamber R for retention of oil between the first cylinder 11 and the second cylinder 12. Along with the movement of the rod 20 relative to the first cylinder 11, oil inside the first cylinder 11 is absorbed into the reservoir chamber R or oil inside the reservoir chamber R is supplied into the first cylinder 11.

### Rod 20

The rod 20 is a rod-shaped member extending in the axial direction. The rod 20 is connected at its other side to the first piston unit 30. The rod 20 is connected at its one side to, for example, a vehicle body via a coupling member and the like (not shown).

### Bottom unit 70

The bottom unit 70 includes a valve seat 71 having multiple oil channels, a first bottom valve 72 on the other side of the valve seat 71, and a second bottom valve 73 on the one side of the valve seat 71. The bottom unit 70 further includes the bolt 74 and the nut 75 for holding the first bottom valve 72 and the second bottom valve 73, respectively, on the valve seat 71. The bottom unit 70 provides partition between a first oil chamber Y1 and the reservoir chamber R.

In a compression stroke, the first bottom valve 72 opens the oil channels in the valve seat 71 to allow oil to flow from the first oil chamber Y1 into the reservoir chamber R while throttling the oil. In a tension stroke, the second bottom valve 73 opens the oil channels in the valve seat 71 to allow oil to flow from the reservoir chamber R into the first oil chamber Y1 while throttling the oil.

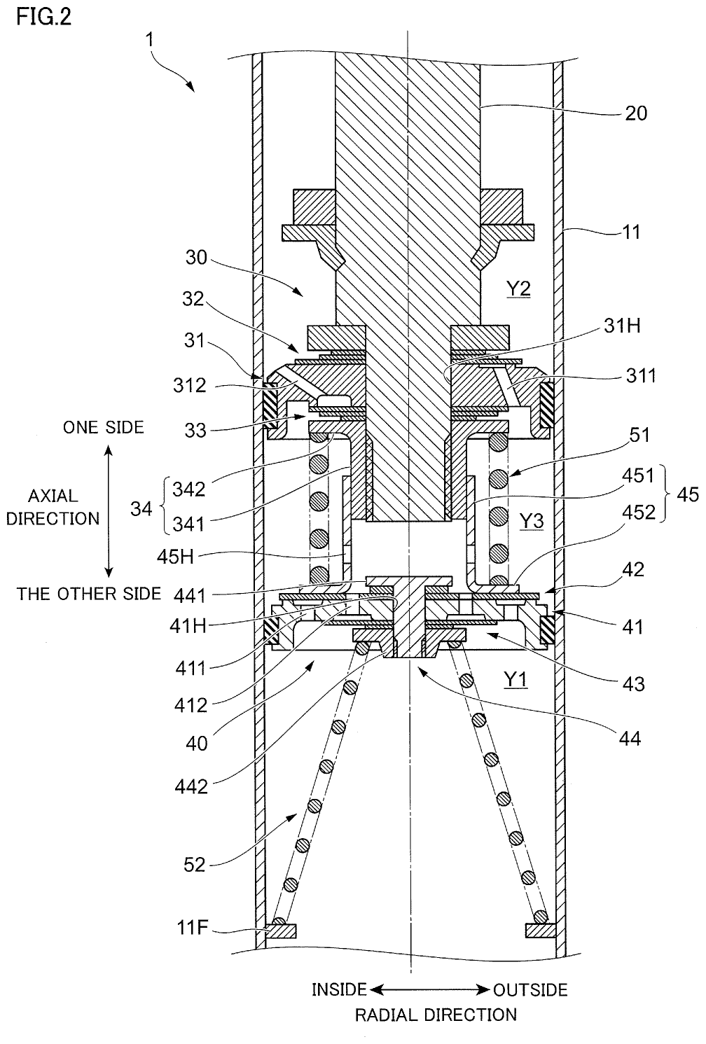

FIG. 2 is a sectional view of the first piston unit 30 and the second piston unit 40 of the first embodiment.

### First Piston Unit 30

As shown in FIG. 2, the first piston unit 30 includes a first piston body 31 having multiple oil channels, a first compression-side damping valve 32 on the one side of the first piston body 31, and a first tension-side damping valve 33 on the other side of the first piston body 31. The first piston unit 30 further includes a first receiver 34 on the other side of the first tension-side damping valve 33.

In the present embodiment, the first piston unit 30 forms an intermediate oil chamber Y3 between the first piston unit 30 and the second piston unit 40. The first piston unit 30 also forms a second oil chamber Y2 for containing oil on the one side of the first piston unit 30 inside the first cylinder 11.

The first piston body 31 includes a through-hole 31H on the inside in the radial direction thereof, first compression-side oil channels 311 on the outside in the radial direction of the through-hole 31H, and first tension-side oil channels 312 on the outside in the radial direction of the through-hole 31H.

The through-hole 31H allows for insertion of the other side end of the rod 20.

The first compression-side oil channels 311 permit flow of oil between the intermediate oil chamber Y3 and the second oil chamber Y2 in a compression stroke of the hydraulic damper 1.

The first tension-side oil channels 312 permit flow of oil between the second oil chamber Y2 and the intermediate oil chamber Y3 in a tension stroke of the hydraulic damper 1.

These multiple first compression-side oil channels 311 and first tension-side oil channels 312 are arranged in a circumferential direction of the first piston body 31.

The first compression-side damping valve 32 is a disk-like plate made of metal, for example. The first compression-side damping valve 32 covers the one side of the first compression-side oil channels 311 and leaves the one side of the first tension-side oil channels 312 always open.

The first tension-side damping valve 33 is a disk-like plate made of metal, for example. The first tension-side damping valve 33 covers the other side of the first tension-side oil channels 312 and leaves the other side of the first compression-side oil channels 311 always open.

The first receiver 34 includes a cylindrical part 341 formed in a cylindrical shape and a flange part 342 projecting from the cylindrical part 341 to the outside in the radial direction. The first receiver 34 is screw-fastened at the cylindrical part 341 to the other side end of the rod 20. Thus, the first receiver 34 is fixed to the rod 20 and does not move relative to the rod 20. Also, the first receiver 34 serves as a fixing member to fix the first piston body 31, the first compression-side damping valve 32, and the first tension-side damping valve 33 to the rod 20.

The flange part 342 receives, on the other side thereof, the first spring 51.

### Second Piston Unit 40

As shown in FIG. 2, the second piston unit 40 includes a second piston body 41 having multiple oil channels, a second compression-side damping valve 42 on the one side of the second piston body 41, and a second tension-side damping valve 43 on the other side of the second piston body 41. The second piston unit 40 further includes a fixing member 44 for fixing the components of the second piston unit 40, and a second receiver 45 on the one side of the second compression-side damping valve 42.

In the present embodiment, the second piston unit 40 forms the intermediate oil chamber Y3 between the second piston unit 40 and the first piston unit 30. The second piston unit 40 also forms the first oil chamber Y1 for containing oil on the other side of the second piston unit 40 inside the first cylinder 11.

The second piston body 41 includes a through-hole 41H on the inside in the radial direction thereof, second compression-side oil channels 411 on the outside in the radial direction of the through-hole 41H, and second tension-side oil channels 412 on the outside in the radial direction of the through-hole 41H.

The through-hole 41H allows for insertion of the fixing member 44. The second compression-side oil channels 411 permit flow of oil between the first oil chamber Y1 and the intermediate oil chamber Y3 in a compression stroke of the hydraulic damper 1. The second tension-side oil channels 412 permit flow of oil between the intermediate oil chamber Y3 and the first oil chamber Y1 in a tension stroke of the hydraulic damper 1.

These multiple second compression-side oil channels 411 and second tension-side oil channels 412 are arranged in a circumferential direction of the second piston body 41.

The second compression-side damping valve 42 is a disk-like plate made of metal, for example. The second compression-side damping valve 42 covers the one side of the second compression-side oil channels 411 and leaves the one side of the second tension-side oil channels 412 always open.

The second tension-side damping valve 43 is a disk-like plate made of metal, for example. The second tension-side damping valve 43 covers the other side of the second tension-side oil channels 412 and leaves the other side of the second compression-side oil channels 411 always open.

The fixing member 44 includes a bolt part 441 and a nut part 442 screw-fastened to the bolt part 441. The bolt part 441 and the nut part 442 sandwich the components of the second piston unit 40 to hold them.

The nut part 442 receives, on the other side thereof, the second spring 52.

The second receiver 45 includes a cylindrical part 451 formed in a cylindrical shape and a flange part 452 projecting from the cylindrical part 451 to the outside in the radial direction. The cylindrical part 451 allows for insertion therethrough of the cylindrical part 341 of the first receiver 34. The cylindrical part 451 slides in the axial direction relative to the cylindrical part 341. Thus, the second receiver 45 is movable in the axial direction as its cylindrical part 451 is guided by the cylindrical part 341 of the first receiver 34. The cylindrical part 451 includes an opening 45H permitting flow of oil between the inside and outside of the cylindrical part 451 in the radial direction.

The flange part 452 receives, on the one side thereof, the first spring 51. The flange part 452 contacts, on the other side thereof, the second compression-side damping valve 42.

In the hydraulic damper 1 of the first embodiment, the maximum damping force generated by the first piston unit 30 is set larger than the maximum damping force generated by the second piston unit 40. Accordingly, the first piston unit 30 serves as a main unit and the second piston unit 40 serves as a sub-unit when damping force is generated in the hydraulic damper 1 of the first embodiment.

In the present embodiment, the first compression-side oil channels 311 or the first tension-side oil channels 312 are an example of the first channel. The first compression-side damping valve 32 or the first tension-side damping valve 33 is an example of the first valve. In the present embodiment, the second compression-side oil channels 411 or the second tension-side oil channels 412 are an example of the second channel. The second compression-side damping valve 42 or the second tension-side damping valve 43 is an example of the second valve.

### First Spring 51

The first spring 51 may be a compression coil spring. In the present embodiment, the first spring 51 is disposed on the other side of the first piston unit 30. Also, the first spring 51 is disposed on the one side of the second piston unit 40. In other words, the first spring 51 is disposed between the first piston unit 30 and the second piston unit 40. One side end of the first spring 51 bears on the first receiver 34 and the other side end of the first spring 51 bears on the second receiver 45.

In the present embodiment, the spring constant of the first spring 51 is larger than that of the second spring 52. In other words, displacement of the first spring 51 under a certain amount of force is smaller than displacement of the second spring 52 under the same certain amount of force. In the present embodiment, this makes the first piston unit 30 and the second piston unit 40 hardly contact each other when the first spring 51 and the second spring 52 are displaced in a compressive direction.

### Second Spring 52

The second spring 52 may be a compression coil spring. In the first embodiment, the second spring 52 is disposed on the other side of the second piston unit 40. One side end of the second spring 52 bears on the nut part 442 of the fixing member 44 and the other side end of the second spring 52 bears on the support 11F of the first cylinder 11.

In the hydraulic damper 1 of the present embodiment, the second piston unit 40 is always supported by the first spring 51 and the second spring 52. In the present embodiment, the second receiver 45 contacts the second compression-side damping valve 42 of the second piston unit 40. As such, spring reaction force caused by displacement of the first spring 51 and the second spring 52 acts on the second compression-side damping valve 42 via the second receiver 45.

The spring constant of the first spring 51 may be the same as that of the second spring 52.

While in the present embodiment the first spring 51 and the second spring 52 are a compression coil spring, they are not limited to a compression coil spring. The first spring 51 and the second spring 52 may be any other elastic member that allows them to always support the second piston unit 40 and to be displaced along with the movement of the rod 20.

### Operation of the Hydraulic Damper 1

Below a description will be given of an operation of the hydraulic damper 1. Here, an operation thereof during a small stroke state will be described.

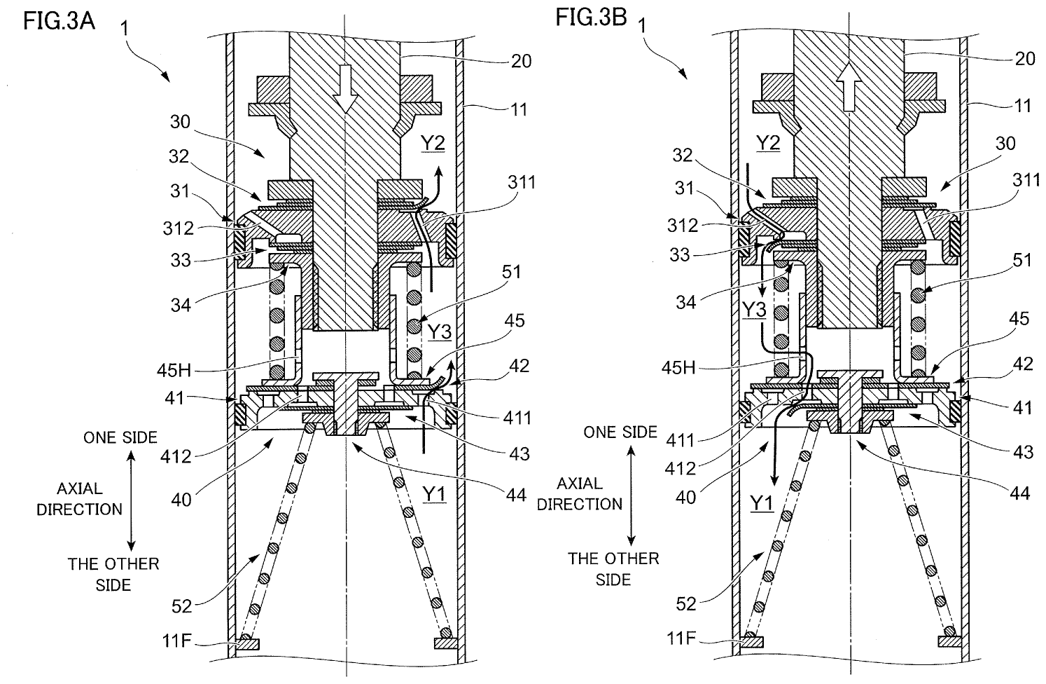

FIGS. 3A and 3B explain how the hydraulic damper 1 operates during a small stroke state in the first embodiment.

FIG. 3A shows oil flow in a compression stroke and FIG. 3B shows oil flow in a tension stroke.

First, a description will be given of an operation of the hydraulic damper 1 in a compression stroke.

As shown in FIG. 3A, in a compression stroke, the rod 20 moves relatively to the other side in the first cylinder 11. In the second piston unit 40, the second compression-side damping valve 42 having closed the second compression-side oil channels 411 opens under a differential pressure between the first oil chamber Y1 and the intermediate oil chamber Y3. At this time, the second compression-side damping valve 42 opens under the differential pressure while being applied with the spring reaction force of the first spring 51 and the second spring 52 acting on the second compression-side damping valve 42 via the second receiver 45. Thus, oil in the first oil chamber Y1 flows into the intermediate oil chamber Y3 through the second compression-side oil channels 411.

In the compression stroke, the first compression-side damping valve 32 of the first piston unit 30 having closed the first compression-side oil channels 311 also opens under a differential pressure between the intermediate oil chamber Y3 and the second oil chamber Y2. Thus, oil in the intermediate oil chamber Y3 flows into the second oil chamber Y2 through the first compression-side oil channels 311.

As described above, the hydraulic damper 1 of the present embodiment generates damping force in the compression stroke by the first piston unit 30 and the second piston unit 40 that are provided in series.

Now a description will be given of an operation of the hydraulic damper 1 in a tension stroke.

As shown in FIG. 3B, in a tension stroke, the rod 20 moves relatively to the one side in the first cylinder 11. In the first piston unit 30, the first tension-side damping valve 33 having closed the first tension-side oil channels 312 opens under a differential pressure between the second oil chamber Y2 and the intermediate oil chamber Y3. Thus, oil in the second oil chamber Y2 flows into the intermediate oil chamber Y3 through the first tension-side oil channels 312.

In the tension stroke, the second tension-side damping valve 43 of the second piston unit 40 having closed the second tension-side oil channels 412 also opens under a differential pressure between the intermediate oil chamber Y3 and the first oil chamber Y1. Thus, oil in the intermediate oil chamber Y3 flows into the first oil chamber Y1 through the second tension-side oil channels 412.

As described above, the hydraulic damper 1 of the present embodiment generates damping force in the tension stroke by the first piston unit 30 and the second piston unit 40 that are provided in series.

Now a description will be given of an operation of the hydraulic damper 1 during the large stroke state.

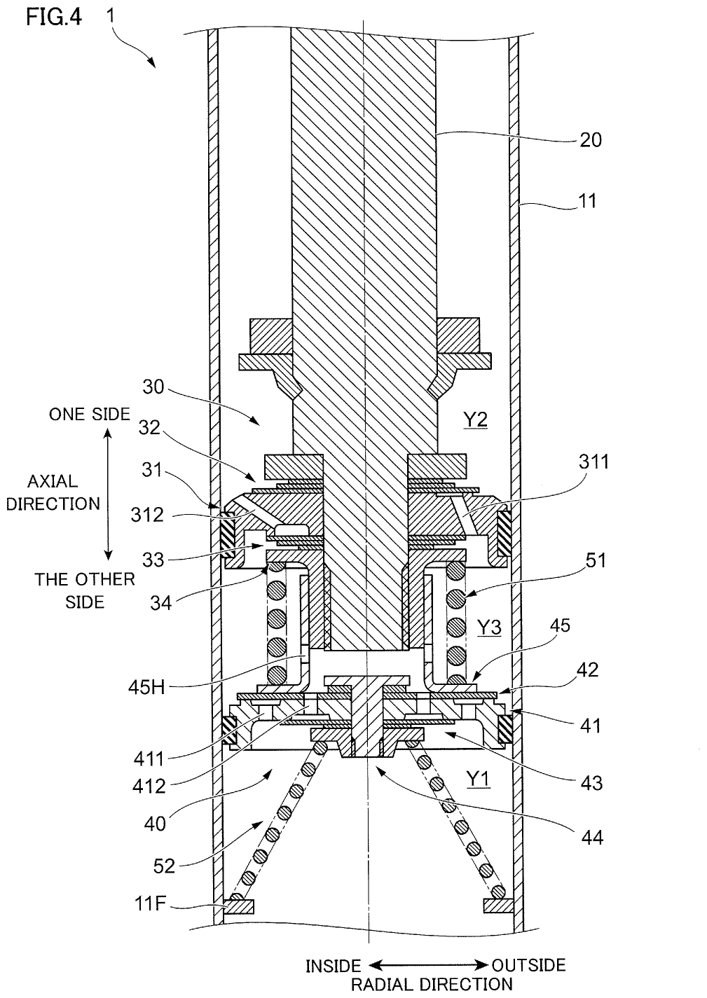

FIG. 4 explains how the hydraulic damper 1 operates during the large stroke state in the first embodiment.

The oil passage in the first piston unit 30 and the second piston unit 40 during the large stroke state is similar to that during the small stroke state as explained with reference to FIGS. 3A and 3B, except that the second piston unit 40 generates greater damping force in a compression stroke during the large stroke state. As a result, the hydraulic damper 1 generates greater damping force in a compression stroke during the large stroke state.

As shown in FIG. 4, during the large stroke state, the first piston unit 30 provided on the rod 20 moves greatly to the other side. Via the first spring 51, the first piston unit 30 moves the second piston unit 40 to the other side. At this time, the first spring 51 is compressed and displaced. Also, movement of the second piston unit 40 to the other side results in the second spring 52 being compressed and displaced.

The spring reaction force caused by the compression of the first spring 51 and the second spring 52 during the large stroke state acts on the second compression-side damping valve 42 via the second receiver 45. The spring reaction force during the large stroke state is larger than that during the small stroke state (see FIG. 2). As a result, the second piston unit 40 generates greater damping force in a compression stroke. In the present embodiment, the second piston unit 40 is provided in series with the first piston unit 30. Thus, the hydraulic damper 1 generates greater damping force in the compression stroke, which is mainly generated by the first piston unit 30 and the second piston unit 40.

As described above, the hydraulic damper 1 of the present embodiment generates relatively small damping force during the small stroke state, which is, for example, where the vehicle is traveling straight on a road at a constant speed. This allows to maintain good vehicle comfort. Meanwhile, the hydraulic damper 1 of the present embodiment generates relatively large damping force during the large stroke state, which is, for example, where the vehicle is under acceleration or hard deceleration or the vehicle height is lowered due to increased load on the vehicle. This allows for increased damping and stability.

As described above, the hydraulic damper 1 of the present embodiment is capable of varying generated damping force according to the position of the rod 20 relative to the cylinder unit 10.

In the hydraulic damper 1 of the first embodiment, the one side of the second spring 52 may directly or indirectly bear on the second tension-side damping valve 43 of the second piston unit 40. In this case, the spring reaction force caused by the compression of the first spring 51 and the second spring 52 may be caused to act on the second tension-side damping valve 43 of the second piston unit 40.

### Second Embodiment

Now a description will be given of the hydraulic damper 1 of the second embodiment.

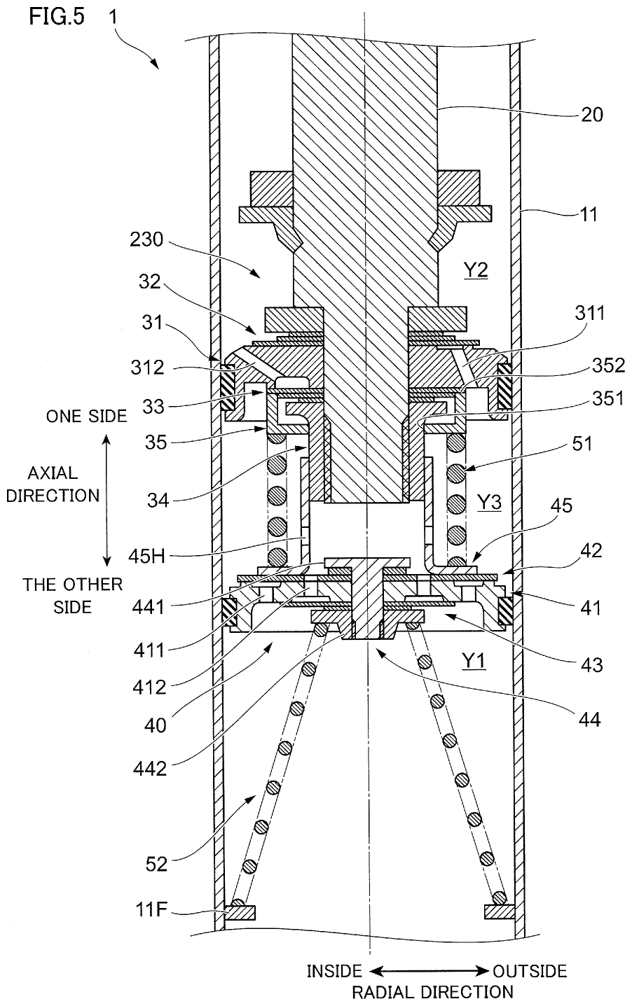

FIG. 5 is a sectional view of a first piston unit 230 and the second piston unit 40 of the second embodiment.

In the description of the second embodiment, components similar to those in the first embodiment are denoted by the same reference numerals, and detailed description thereof will be omitted.

### First Piston Unit 230

As shown in FIG. 5, in the second embodiment of the hydraulic damper 1, the configuration of a first piston unit 230 differs from the first piston unit 30 of the first embodiment. Specifically, the first piston unit 230 of the second embodiment includes the first piston body 31, the first compression-side damping valve 32, the first tension-side damping valve 33, the first receiver 34, and a pressing member 35 pressed against the first tension-side damping valve 33.

In the second embodiment, the first receiver 34 does not support the first spring 51. The first receiver 34 guides the pressing member 35 such that the pressing member 35 can move in the axial direction.

The pressing member 35 includes a guided part 351 guided by the first receiver 34, and a valve contacting part 352 contacting the first tension-side damping valve 33. The guided part 351 is slidable in the axial direction relative to the first receiver 34. With the guided part 351 guided by the first receiver 34, the pressing member 35 is movable in the axial direction.

In the hydraulic damper 1 of the second embodiment, the other side end of the first spring 51 bears on the second receiver 45 and the one side end of the first spring 51 bears on the pressing member 35.

Below a description will be given of an operation of the hydraulic damper 1 of the second embodiment during the large stroke state.

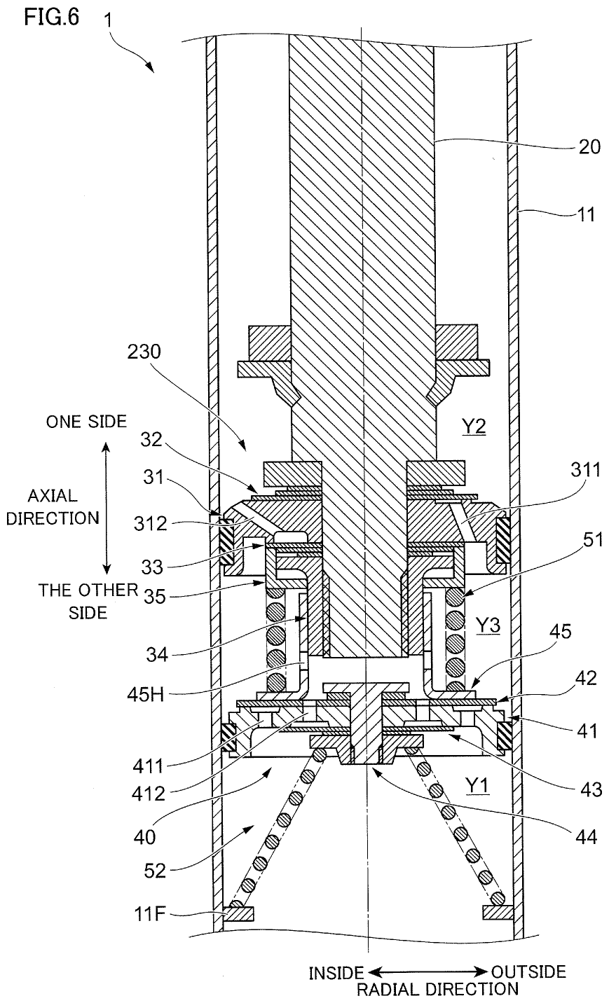

FIG. 6 explains how the hydraulic damper 1 operates during the large stroke state in the second embodiment.

The oil flow in the hydraulic damper 1 of the second embodiment is basically same as that in the first embodiment.

However, the hydraulic damper 1 of the second embodiment can generate, both in compression and tension strokes, greater damping force during the large stroke state than during the small stroke state.

As shown in FIG. 6, during the large stroke state, the first piston unit 230 provided on the rod 20 moves greatly to the other side. Via the first spring 51, the first piston unit 230 moves the second piston unit 40 to the other side. In this state, the first spring 51 is compressed and displaced.

Also, movement of the second piston unit 40 to the other side results in the second spring 52 being compressed and displaced.

The spring reaction force caused by the compression of the first spring 51 and the second spring 52 acts on the second compression-side damping valve 42 via the second receiver 45. This spring reaction force is larger than that during the small stroke state. As a result, the second piston unit 40 generates greater damping force in a compression stroke during the large stroke state.

The spring reaction force caused by the compression of the first spring 51 and the second spring 52 also acts on the first tension-side damping valve 33 via the pressing member 35. This spring reaction force is larger than that during the small stroke state. As a result, the second piston unit 40 generates greater damping force in a tension stroke during the large stroke state.

As described above, the hydraulic damper 1 of the second embodiment generates greater damping force during the large stroke state than during the small stroke state both in compression and tension strokes.

### Third Embodiment

Now a description will be given of the hydraulic damper 1 of the third embodiment.

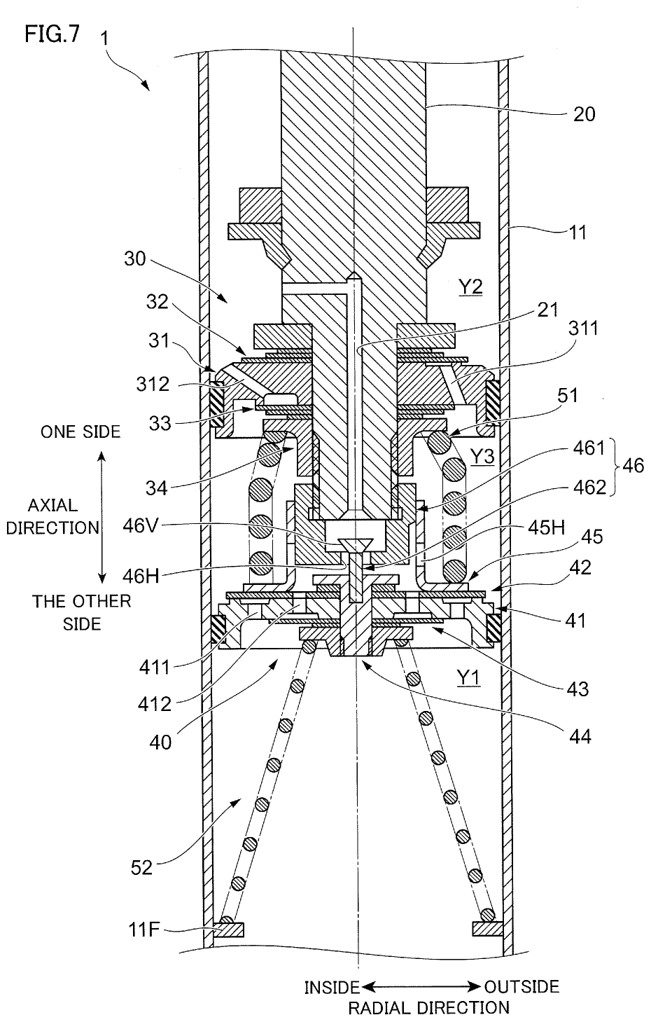

FIG. 7 is a sectional view of the first piston unit 30 and a second piston unit 240 of the third embodiment.

In the description of the third embodiment, components similar to those in the first embodiment are denoted by the same reference numerals, and detailed description thereof will be omitted.

As shown in FIG. 7, the hydraulic damper 1 of the third embodiment includes the rod 20 having an orifice channel 21. In the third embodiment, the orifice channel 21 is formed by perforating the rod 20. The orifice channel 21 connects on its other side to the intermediate oil chamber Y3 and connects on its one side to the second oil chamber Y2. The orifice channel 21 is a channel that allows oil to bypass the first compression-side oil channels 311 and the first tension-side oil channels 312 respectively opening the first compression-side damping valve 32 and the first tension-side damping valve 33 of the first piston unit 30.

### Second Piston Unit 240

As shown in FIG. 7, in the third embodiment of the hydraulic damper 1, the configuration of a second piston unit 240 differs from the second piston unit 40 of the first embodiment. Specifically, the second piston unit 240 of the third embodiment includes the second piston body 41, the second compression-side damping valve 42, the second tension-side damping valve 43, the fixing member 44, the second receiver 45, and an orifice adjuster 46 for controlling oil flow in the orifice channel 21.

The orifice adjuster 46 includes a channel forming member 461 communicating with the orifice channel 21, and a control valve 462 (an example of the control part) that moves relative to the channel forming member 461.

The channel forming member 461 connects on its one side to the rod 20 and includes an opening 46H on its other side. The opening 46H defines a path through which oil from the orifice channel 21 can pass.

The control valve 462 connects on its other side to the fixing member 44 and includes on its one side an opening/closing part 46V configured to open and close the opening 46H. The outer diameter on the one side of the opening/closing part 46V is larger than that on the other side thereof. In the present embodiment, the opening/closing part 46V has a tapered shape with its other side narrower than its one side. The control valve 462 is provided so as to penetrate the opening 46H.

The orifice adjuster 46 controls oil flow in the orifice channel 21 by changing the position of the opening/closing part 46V relative to the opening 46H according to movement of the rod 20.

When the hydraulic damper 1 of the third embodiment is under the small stroke state due to, for example, the rod 20 moving relative to the cylinder unit 10 at a relatively low speed, or a relatively low frequency, the opening/closing part 46V is positioned away from the opening 46H. In this state, the orifice adjuster 46 permits oil flow in the orifice channel 21. In other words, the orifice adjuster 46 allows oil to bypass the first piston unit 30. Thus, during the small stroke state for example, at least the first piston unit 30 is restrained from generating damping force, and damping force is instead generated by resistance to oil flow in the orifice channel 21 and by the second piston unit 40. This damping force is smaller than damping force generated by the combination of the first piston unit 30 and the second piston unit 40.

Meanwhile, when the hydraulic damper 1 of the third embodiment is under the large stroke state due to, for example, the rod 20 moving relative to the cylinder unit 10 at a relatively high speed, or a relatively high frequency, the second piston unit 40 becomes unable to follow the movement of the first piston unit 30. In this state, the opening/closing part 46V contacts or approaches the opening 46H as the relative distance between the first piston unit 30 and the second piston unit 40 increases. Thus, the orifice adjuster 46 restricts oil flow in the orifice channel 21. As such, during the large stroke state, damping force is generated by the first piston unit 30 and the second piston unit 40. This damping force is larger than the damping force during the small stroke state described above.

As described above, the hydraulic damper 1 of the third embodiment is capable of varying generated damping force by controlling the oil flow in the orifice channel 21 by the orifice adjuster 46 according to the position of the rod 20 relative to the cylinder unit 10.

### Fourth Embodiment

Below a description will be given of the hydraulic damper 1 of the fourth embodiment.

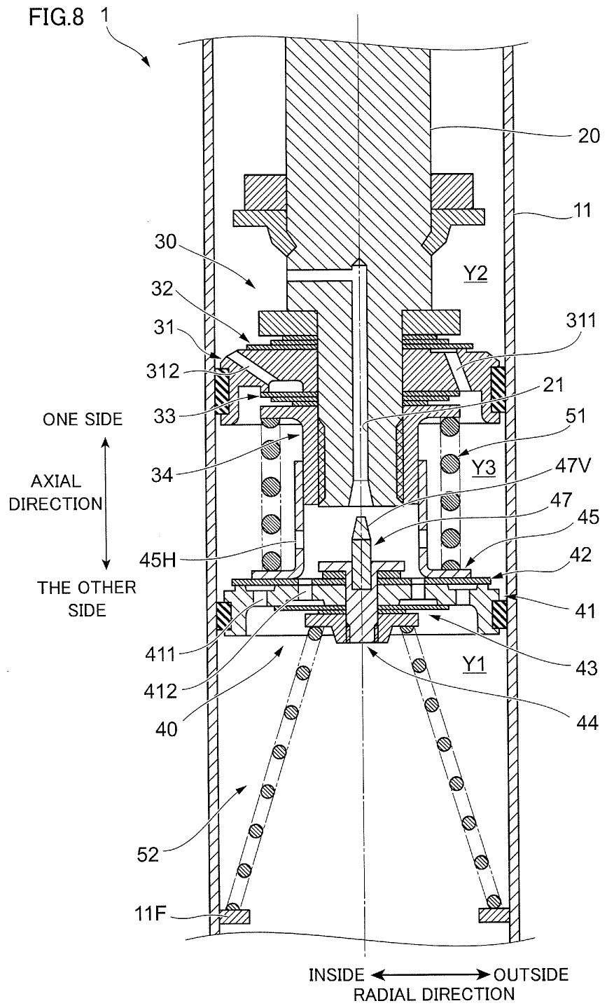

FIG. 8 is a sectional view of the first piston unit 30 and a second piston unit 340 of the fourth embodiment.

In the description of the fourth embodiment, components similar to those in other embodiments are denoted by the same reference numerals, and detailed description thereof will be omitted.

As shown in FIG. 8, the basic configuration of the hydraulic damper 1 of the fourth embodiment is similar to that of the third embodiment. For example, the rod 20 in the fourth embodiment includes the orifice channel 21.

### Second Piston Unit 340

The second piston unit 340 of the fourth embodiment includes the second piston body 41, the second compression-side damping valve 42, the second tension-side damping valve 43, the fixing member 44, the second receiver 45, and a control valve 47 (an example of the control part) for controlling oil flow in the orifice channel 21.

The control valve 47 connects on its other side to the fixing member 44 and includes on its one side an opening/closing part 47V configured to open and close the orifice channel 21. The outer diameter on the one side of the opening/closing part 47V is smaller than that on the other side thereof. In the present embodiment, the opening/closing part 47V has a tapered shape with its one side narrower than its other side.

In the hydraulic damper 1 of the fourth embodiment, the control valve 47 controls oil flow in the orifice channel 21 by changing the position of the opening/closing part 47V relative to the orifice channel 21 according to movement of the rod 20.

When the hydraulic damper 1 of the fourth embodiment is under the small stroke state, the opening/closing part 47V is positioned away from the orifice channel 21. In this state, the control valve 47 permits oil flow in the orifice channel 21. In other words, the control valve 47 allows oil to bypass the first piston unit 30. Thus, during the small stroke state for example, at least the first piston unit 30 is restrained from generating damping force, and damping force is instead generated by resistance to oil flow in the orifice channel 21 and by the second piston unit 40. This damping force is smaller than damping force generated by the combination of the first piston unit 30 and the second piston unit 40.

Meanwhile, when the hydraulic damper 1 of the fourth embodiment is under the large stroke state, the opening/closing part 47V approaches the orifice channel 21. In particular, when the opening/closing part 47V contacts or approaches the other side opening of the orifice channel 21, the control valve 47 restricts oil flow in the orifice channel 21. As such, during the large stroke state, damping force is generated by the first piston unit 30 and the second piston unit 40. This damping force is larger than the damping force during the small stroke state described above.

As described above, the hydraulic damper 1 of the fourth embodiment is capable of varying generated damping force by controlling the oil flow in the orifice channel 21 by the control valve 47 according to the position of the rod 20 relative to the cylinder unit 10.

In the third and fourth embodiments in particular, simply changing the shape of the orifice adjuster 46 or the control valve 47 allows to modify the control of oil flow in the orifice channel 21. As such, the hydraulic damper 1 of the third and fourth embodiments allows for flexible design of damping force characteristics.

### Fifth Embodiment

Below a description will be given of the hydraulic damper 1 of the fifth embodiment.

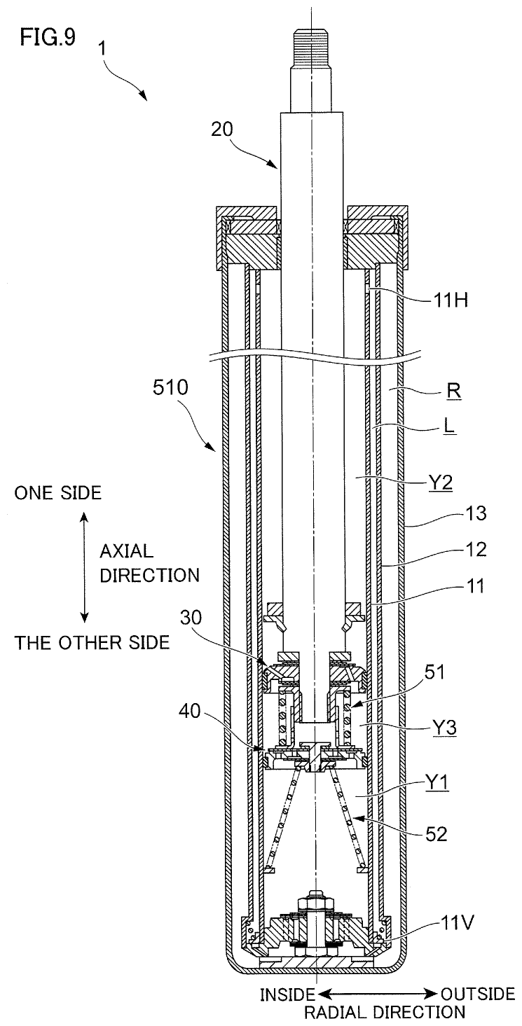

FIG. 9 is an entire view of the hydraulic damper 1 of the fifth embodiment.

In the description of the fifth embodiment, components similar to those in other embodiments are denoted by the same reference numerals, and detailed description thereof will be omitted.

As shown in FIG. 9, in the fifth embodiment of the hydraulic damper 1, the configuration of a cylinder unit 510 differs from other embodiments.

### Cylinder Unit 510

The cylinder unit 510 includes the first cylinder 11, the second cylinder 12 on the outside in the radial direction of the first cylinder 11, and a third cylinder 13 further on the outside in the radial direction of the second cylinder 12. That is, the hydraulic damper 1 of the fifth embodiment has a so-called triple tube structure.

The first cylinder 11 is formed in a cylindrical shape and includes on its one side the cylinder opening 11H. The cylinder opening 11H provides communication between the second oil chamber Y and a communication path L, which will be described later.

The second cylinder 12 is formed in a cylindrical shape. The second cylinder 12 forms the communication path L between the second cylinder 12 and the first cylinder 11.

The third cylinder 13 is formed in a cylindrical shape. The third cylinder 13 forms the reservoir chamber R for retention of oil between the third cylinder 13 and the second cylinder 12. Along with the movement of the rod 20 relative to the first cylinder 11, oil inside the first cylinder 11 is absorbed into the reservoir chamber R or oil inside the reservoir chamber R is supplied into the first cylinder 11.

The cylinder unit 510 includes, on its other side end, a lift valve 11V for controlling oil flow in the communication path L. In a tension stroke, the lift valve 11V restricts oil flowing from the second oil chamber Y2 through the communication path L into the reservoir chamber R. In other words, the lift valve 11V restricts oil flow from the second oil chamber Y2 into the communication path L in a tension stroke. Meanwhile, in a compression stroke, the lift valve 11V permits oil to flow from the reservoir chamber R through the communication path L into the second oil chamber Y2. In other words, the lift valve 11V permits oil flow from the communication path L into the second oil chamber Y2 in a compression stroke.

In the above-configured hydraulic damper 1 of the fifth embodiment, oil flow in the first piston unit 30 and the second piston unit 40 is similar to that as explained with reference to FIGS. 3A, 3B and 4.

In the hydraulic damper 1 of the fifth embodiment, in a compression stroke, oil is supplied from the communication path L into the second oil chamber Y2 which has been reduced in pressure due to the first piston unit 30 and the second piston unit 40 moving to the other side. This, for example, prevents cavitation and other problems that may otherwise be caused by pressure reduction in the second oil chamber Y2. As such, the hydraulic damper 1 of the fifth embodiment is less prone to restrictions such as needing to lower the damping force generated by the first piston unit 30 and the second piston unit 40 to prevent pressure reduction in the second oil chamber Y2. In other words, the hydraulic damper 1 of the fifth embodiment allows for more flexible design, including increasing the damping force generated by the first piston unit 30 and the second piston unit 40.

In the first embodiment, the first spring 51 exerts spring force on the second compression-side damping valve 42 of the second piston unit 40 via the second receiver 45. The present invention is, however, not limited to this configuration. Alternatively, the first spring 51 may exert spring force on the second compression-side damping valve 42 by, for example, directly contacting the second compression-side damping valve 42. This applies to the other embodiments.

In the first to the fifth embodiments, the second piston unit 40 is provided on the bottom unit 70 side relative to the first piston unit 30. However, the present invention is not limited to this configuration.

Alternatively, the second piston unit 40 may be provided on the rod 20 side relative to the first piston unit 30. In this case, the second piston unit 40 is configured to allow for insertion of the rod 20 and move relative to the rod 20. Also, in this case, the first spring 51 is provided between the first piston unit 30 and the second piston unit 40, and the second spring 52 is provided on the one side of the second piston unit 40.

Still alternatively, multiple second piston units 40 may be provided.

In this case, the second piston units 40 may be provided respectively on the other side of the first piston unit 30 and on the one side of the first piston unit 30. In this case too, the first spring 51 may be provided between the first piston unit 30 and the second piston unit 40, and the second spring 52 may be provided on an opposite side of the second piston unit 40 from its side where the first spring 51 is provided.

In the hydraulic damper 1 of the third and the fourth embodiments, the orifice channel 21 is formed by perforating the rod 20. However, the present invention is not limited to this configuration. The hydraulic damper 1 is only required to have a path that allows oil to bypass the first compression-side oil channels 311 and the first tension-side oil channels 312 of the first piston unit 30 generating damping force. For example, the hydraulic damper 1 may alternatively include an oil channel between the rod 20 and the first piston body 31 or another path in the first piston body 31 that is different from the first compression-side oil channels 311 and the first tension-side oil channels 312.

It should be noted that some configurations in one of the first to the fifth embodiments may be combined or replaced with configurations in another one of the embodiments.

### REFERENCE SIGNS LIST

1 Hydraulic damper

10 Cylinder unit

20 Rod

30 First piston unit

31 First piston body

32 First compression-side damping valve

33 First tension-side damping valve

40 Second piston unit

41 Second piston body

42 Second compression-side damping valve

43 Second tension-side damping valve

51 First spring

52 Second spring

1. A hydraulic damper comprising:
a cylinder configured to extend from one side to the other side and contain liquid;
a rod configured to move relative to the cylinder;
a first piston configured to move relative to the cylinder inside the cylinder along with relative movement of the rod and generate damping force;
a first elastic member having elasticity and provided inside the cylinder, the first elastic member being configured to be displaced along with the relative movement of the rod;
a second elastic member having elasticity and provided separately from the first elastic member inside the cylinder, the second elastic member being configured to be displaced along with the relative movement of the rod; and
a second piston provided separately from the first piston, the second piston being configured to move relative to the cylinder inside the cylinder, the second piston being configured to be always supported by the first elastic member and the second elastic member such that the second piston is movable inside the cylinder, the second piston being configured to generate damping force that varies according to displacement of the first elastic member and the second elastic member.

2. The hydraulic damper according to claim 1, wherein
the first elastic member is provided on the one side of the second piston, and
the second elastic member is provided on the other side of the second piston.

3. The hydraulic damper according to claim 1, wherein
the first elastic member is provided between the first piston and the second piston,
the second elastic member is provided on an opposite side of the second piston from a side thereof where the first elastic member is provided, and
a spring constant of the first elastic member is equal to or larger than a spring constant of the second elastic member.

4. The hydraulic damper according to claim 1, further comprising an orifice channel configured to allow the liquid to bypass the first piston.

5. The hydraulic damper according to claim 1, further comprising:
an orifice channel configured to allow the liquid to bypass the first piston; and
a control part configured to control flow of the liquid in the orifice channel according to distance between the first piston and the second piston.

6. The hydraulic damper according to claim 1, wherein
the first elastic member is provided on the one side of the second piston,
the second elastic member is provided on the other side of the second piston, and
the hydraulic damper further comprises an orifice channel configured to allow the liquid to bypass the first piston.

7. The hydraulic damper according to claim 1, wherein the second piston is provided either on the one side of the first piston, on the other side of the first piston, or on both of the one and the other sides of the first piston.

8. The hydraulic damper according to claim 1, wherein
the first piston comprises a first channel and a first valve, the first channel being configured to allow the liquid to pass therethrough along with movement of the first piston relative to the cylinder, the first valve being configured to open and close the first channel,
the second piston comprises a second channel and a second valve, the second channel being configured to allow the liquid to pass therethrough along with movement of the second piston relative to the cylinder, the second valve being configured to open and close the second channel, and
elastic force caused by displacement of the first elastic member and the second elastic member acts on at least one of the first valve and the second valve.
